(19) United States
(12) Patent Application Publication
(10) Pub. No.: US 2021/0041677 A1
(43) Pub. Date: Feb. 11, 2021

(54) IRRADIATION OPTICAL SYSTEM, LIGHT IRRADIATION DEVICE, AND THREE-DIMENSIONAL FABRICATING APPARATUS

(71) Applicants: Hirotoshi NAKAYAMA, Kanagawa (JP); Kohji SAKAI, Tokyo (JP)

(72) Inventors: Hirotoshi NAKAYAMA, Kanagawa (JP); Kohji SAKAI, Tokyo (JP)

(21) Appl. No.: 16/940,622

(22) Filed: Jul. 28, 2020

(30) Foreign Application Priority Data
Aug. 7, 2019 (JP) 2019-145642

(51) Int. Cl. G02B 13/08; G02B 9/34; G02B 5/10

(52) U.S. Cl. CPC G02B 13/08; G02B 5/10; G02B 9/34

(57) ABSTRACT

An irradiation optical system includes a light source unit and an irradiation unit. The irradiation unit is configured to condense light from the light source unit onto an irradiated surface to irradiate the irradiated surface with the light. In the irradiation unit, a direction of an optical axis is a Z direction, two directions orthogonal to the optical axis and orthogonal to each other are an X direction and a Y direction, and a positive power in the X direction is set to be smaller than a positive power in the Y direction such that a condensing spot on an X-Y plane at a position where the light from the light source unit is condensed has an elliptical shape having the X direction as a major axis.

### CROSS-REFERENCE TO RELATED APPLICATION

This patent application is based on and claims priority pursuant to 35 U.S.C. § 119(a) to Japanese Patent Application No. 2019-145642, filed on Aug. 7, 2019, in the Japan Patent Office, the entire disclosure of which is incorporated by reference herein.

### BACKGROUND

### TECHNICAL FIELD

Aspects of the present disclosure relate to an irradiation optical system, a light irradiation device, and a three-dimensional fabricating apparatus. Related Art

A “three-dimensional fabricating apparatus” capable of fabricating a three-dimensional object is commercialized.

There are various fabrication methods for fabricating a three-dimensional shape, and as a general method, an “additive manufacturing method” is well known.

The “additive manufacturing method” is a method by which a three-dimensional shape to be fabricated is cut into a large number of layers (N layers) in one direction (for example, upward and downward direction) and a fabrication material is sequentially stacked from a first layer to an N^{th} layer to fabricate the three-dimensional shape.

In the three-dimensional fabrication by the additive manufacturing method, when the layers stacked in the N layers are not integrated with each other with sufficient strength, a fabricated three-dimensional fabrication object has insufficient strength to become brittle, and thus the shape is easily damaged.

There is proposed a method for improving the strength of the three-dimensional fabrication object. For example, there is known “a method by which immediately before a molten resin of a fabrication material is stacked, a lower layer is irradiated with laser light to enter a semi-molten state and thus the adhesion of the lower layer is improved, thereby improving the strength of a three-dimensional object”.

### SUMMARY

In an aspect of the present disclosure, there is provided an irradiation optical system that includes a light source unit and an irradiation unit. The irradiation unit is configured to condense light from the light source unit onto an irradiated surface to irradiate the irradiated surface with the light. In the irradiation unit, a direction of an optical axis is a Z direction, two directions orthogonal to the optical axis and orthogonal to each other are an X direction and a Y direction, and a positive power in the X direction is set to be smaller than a positive power in the Y direction such that a condensing spot on an X-Y plane at a position where the light from the light source unit is condensed has an elliptical shape having the X direction as a major axis.

In another aspect of the present disclosure, there is provided a light irradiation device that includes the irradiation optical system and a holder. The irradiation optical system is configured to irradiate the irradiated surface with light. The holder is configured to hold the irradiation unit in the irradiation optical system such that the Z direction is inclined to the Y direction by an inclination angle θ with respect to a direction of a normal line of the irradiated surface and an irradiation spot in which a diameter of the condensing spot in the Y direction is 1/cos θ times a diameter of the condensing spot in the X direction is formed on the irradiated surface.

In still another aspect of the present disclosure, there is provided a three-dimensional fabricating apparatus configured to stack layers of a fabrication material forming a three-dimensional shape on a placement surface while displacing the placement surface of a placement table in a stepwise manner in a direction of a normal line of the placement surface, to form the three-dimensional shape. The three-dimensional fabricating apparatus includes a material supplier and the light irradiation device. The material supplier is configured to supply the fabrication material onto the placement surface from the direction of the normal line. The light irradiation device is configured to irradiate a vicinity of a supply portion, to which the material supplier supplies the fabrication material, with light while supplying the fabrication material from the material supplier onto an immediately previous layer formed of the fabrication material supplied from the material supplier, to melt the immediately previous layer in the vicinity.

### BRIEF DESCRIPTION OF THE DRAWINGS

The aforementioned and other aspects, features, and advantages of the present disclosure would be better understood by reference to the following detailed description when considered in connection with the accompanying drawings, wherein:

FIGS. 1A to 1C are illustrations of a case where a light irradiation device is used in a three-dimensional fabricating apparatus;

FIG. 2 is an illustration of an example where an irradiation unit includes four lenses;

FIG. 3 is an illustration of a first example of the irradiation unit;

FIG. 4 is an illustration of a second example of the irradiation unit;

FIG. 5 is an illustration of a third example of the irradiation unit;

FIG. 6 is an illustration of a fourth second example of the irradiation unit;

FIG. 7 is an illustration of power arrangements of the first to third examples of the irradiation unit;

FIG. 8 is an illustration of a power arrangement of the fourth example of the irradiation unit;

FIGS. 9A to 9C are illustrations of Example 1;

FIGS. 10A to 10C are illustrations of Example 2;

FIGS. 11A to 11C are illustrations of Example 3;

FIGS. 12A to 12C are illustrations of Example 4;

FIG. 13 is an illustration of the three-dimensional fabricating apparatus according to an embodiment of the present disclosure;

FIG. 14 is an illustration of a relationship between an opening shape of a nozzle discharging a fabrication material and an irradiation spot;

FIG. 15 is an illustration of one example of movement of an irradiation optical system;

FIG. 16 is an illustration of another example of movement of the irradiation optical system; and

FIG. 17 is an illustration of one example of the irradiation unit.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Although the embodiments are described with technical limitations with reference to the attached drawings, such description is not intended to limit the scope of the disclosure and all of the components or elements described in the embodiments of this disclosure are not necessarily indispensable.

Referring now to the drawings, embodiments of the present disclosure are described below. In the drawings for explaining the following embodiments, the same reference codes are allocated to elements (members or components) having the same function or shape and redundant descriptions thereof are omitted below.

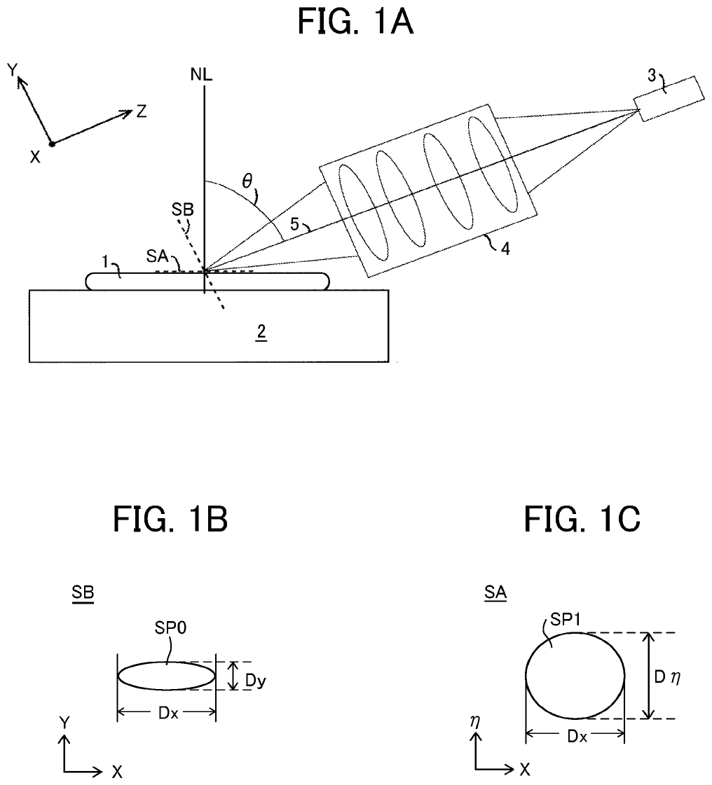

FIGS. 1A to 1C are illustrations of a case where a light irradiation device according to an embodiment of the present disclosure is used in a three-dimensional fabricating apparatus.

FIG. 1A illustrates a fabrication material layer 1, a placement table 2, a light source unit 3, and an irradiation unit 4.

Namely, FIG. 1A illustrates a state where the fabrication material layer 1 is formed on a placement surface of the placement table 2. The drawing illustrates a “state where only one fabrication material layer 1 is formed”. However, when a three-dimensional shape is fabricated, a large number of layers into which the three-dimensional shape to be fabricated is cut are stacked on the fabrication material layer 1.

A surface that is depicted as the surface of the fabrication material layer 1 and denoted by reference sign SA is referred to as an “irradiated surface”. The irradiated surface SA is parallel to the placement surface of the placement table 2.

A normal line standing on the irradiated surface SA is represented as a normal line NL in the drawing.

The light source unit 3 and the irradiation unit 4 form an “irradiation optical system”. The irradiation unit 4 condenses light from the light source unit 3 onto the irradiated surface SA to irradiate the irradiated surface SA with the light. A light emitter of the light source unit 3 is a very small point light source and is located at a fixed position on an optical axis 5 of the irradiation unit 4.

A specific one example of the light source unit 3 may be a light source unit including, as a light emitter, a small light-emitting end of an optical fiber guiding laser light from a laser light source such as a semiconductor laser.

In FIG. 1A, X, Y, and Z directions are determined as illustrated in the drawing.

The X direction is a direction orthogonal to the drawing sheet, and the Y direction and the Z direction are orthogonal to the X direction and are orthogonal to each other. The Z direction is parallel to the direction of the optical axis of the irradiation unit 4.

The optical axis 5 of the irradiation unit 4 is inclined in a Y-Z plane by an angle θ with respect to the normal line NL of the irradiated surface SA.

In FIG. 1A, a plane denoted by reference sign SB is a plane orthogonal to the optical axis 5 of the irradiation unit 4, and intersects the irradiated surface SA at a position where irradiation light is condensed by the irradiation unit 4.

FIG. 1B illustrates a condensing spot SP0 of the irradiation light on a plane SB.

Since the plane SB is orthogonal to the optical axis 5, the plane SB is parallel to the X and Y directions as illustrated in the drawing. Hereinafter, the plane SB is also referred to as an “X-Y plane SB” at the focal position of the condensing spot SP0.

As illustrated in FIG. 1B, the feature of the irradiation optical system according to an embodiment of the present disclosure is that the condensing spot SP0 having “an elliptical shape with the major axis in the X direction” is condensed on the X-Y plane SB.

FIG. 1C illustrates the irradiated surface SA and an irradiation spot SP1 in which the irradiated surface SA is irradiated with light.

As apparent from FIG. 1A, since the optical axis 5 is inclined in the Y-Z plane by the angle θ with respect to the normal line NL and the X-Y plane SB is orthogonal to the optical axis 5, the irradiated surface SA is inclined by the angle θ with respect to the X-Y plane SB.

As illustrated in FIG. 1C, the X direction and an η direction are taken on the irradiated surface. The X direction and the X direction in the X-Y plane SB are common. The η direction is “parallel to the Y-Z plane”.

As illustrated in FIG. 1B, the diameter of the condensing spot SP0 is Dx in the X direction and Dy in the Y direction. As illustrated in FIG. 1C, the diameter of the irradiation spot SP1 is Dx in the X direction and Dη in the η direction.

The diameters Dx, Dy, and Dη have the following relationship.

Namely, the diameter Dx is common to the irradiated surface SA and the X-Y plane SB, and the following relationship is established between the diameter Dy and the diameter Dη.

Dη·cos θ=Dy

Namely,

Dη=Dy/cos θ.

Therefore, the irradiated surface SA is irradiated with light in the irradiation spot SP1 that is stretched by (1/cos θ) times the shape of the condensing spot SP0 in the η direction.

The description will be supplemented.

Regarding three-dimensional fabrication to be fabricated by the additive manufacturing method, it is assumed that fabrication material layers to be stacked are N layers and are stacked in order from a first layer (n=1) to an n−1^{th} layer where n is “1 to N”, and an n^{th} layer is stacked on the n−1 layer. In this case, the n−1 layer is referred to as an “immediately previous layer” with respect to the n^{th} layer to be actually stacked.

In FIG. 1A, the fabrication material layer 1 is the first layer and is an “immediately previous layer” with respect to a second layer to be stacked on the first layer.

When light irradiation is performed in order to improve the strength of a three-dimensional fabrication object, the position where the light irradiation is performed (hereinafter, referred to as a “light irradiation position”) is in the vicinity of “a material supply position, to which a material supplier supplies a fabrication material” to stack and form the nth layer, on the immediately previous layer.

Namely, the “surface of the immediately previous layer” is an irradiated surface and the vicinity of the material supply position as a light irradiation position is irradiated with light, so that the vicinity of the surface enters a molten state.

In this state, when the fabrication material in a molten state is supplied, the supplied fabrication material is mixed with the molten state of the “surface of the n−1^{th} layer in a molten state” to enhance mutual affinity, so that the n^{th} layer strongly bonded to the n−1^{th} layer is formed.

As described above, since the light irradiation position is in the vicinity of the material supply position of the material supplier, when light irradiation means is provided close to the material supply position, mechanical interference between the light irradiation means and the material supplier is likely to occur.

As illustrated in FIG. 1A, when the optical axis 5 of the irradiation optical system is inclined with respect to the irradiated surface SA to perform light irradiation from an oblique direction, the above mechanical interference can be effectively avoided.

However, in this case, when the shape of a condensing spot that the irradiation optical system condenses on the X-Y plane is a “circular shape”, an irradiation spot in which the irradiated surface SA is irradiated with light is stretched by (1/cos θ) times the circular shape in the η direction, so that the irradiation spot has an “elliptical shape which is long in the η direction” and the irradiation area is increased. Therefore, the energy supplied per unit area is reduced.

For this reason, the immediately previous layer is insufficiently melted and when the fabrication material is supplied, the immediately previous layer enters an insufficient molten state. Therefore, bonding between the immediately previous layer and the n^{th} layer is likely to be insufficient.

As in the present embodiment, when the shape of the condensing spot SP0 condensed on the X-Y plane SB is compressed in the Y direction to become an “elliptical shape having the X direction as a major axis direction”, it is possible to implement the irradiation spot SP1 which is favorable on the irradiated surface SA.

In particular, when the spot diameters Dx and Dy illustrated in FIG. 1B are set to “Dx=Dη and Dy=Dη·cos θ” with respect to the spot diameter Dη illustrated in FIG. 1C, the irradiation spot SP1 has a “perfect circular shape”.

The fabrication material is supplied from a nozzle of the material supplier to a melting region of “the n−1^{th} layer that is irradiated and melted with the irradiation spot”.

The cross-sectional shape of an opening portion of the nozzle is a substantially perfect circular shape. The fabrication material is pushed and discharged in a cylindrical shape having a perfect circular cross section from the opening portion.

As described above, since the cross-sectional shape of the fabrication material to be supplied is a perfect circular shape, in order that the fabrication material supplied from the nozzle is favorably bonded to a melting region of the immediately previous layer, it is required that the shape of the melting region is also close to a circular shape and the cross-sectional shape (perfect circular shape) of the fabrication material supplied to the melting region overlaps well the melting region.

When the shape of the irradiation spot SP1 is “a perfect circular shape or a shape close to the perfect circular shape”, the “surface of the immediately previous layer” can be favorably melted by the irradiation spot SP1, and adhesion between the n^{th} layer and the “material surface of the n−1^{th} layer” can be improved.

The nozzle of the material supplier is relatively displaced with respect to the placement table and the fabrication material layer, and it is preferable that the “vicinity in a displacement direction” for the relative displacement of the nozzle is irradiated with light. Namely, in the above example, it is preferable that the η direction is set to the displacement direction of the nozzle.

It is preferable that the shape of the irradiation spot SP1 is, as described above, a “perfect circular shape or a shape close to the perfect circular shape”. It is preferable that a ratio Dη/Dx between Dη and Dx is within a range of

1.8≥Dη/Dx ≥0.8.

When the ratio is larger than an upper limit value of 1.8, the energy supplied per unit area of an irradiation region of the immediately previous layer is likely to be reduced, and it is difficult to implement a favorable molten state of the irradiation region.

When the ratio is less than a lower limit value of 0.8, the cross-sectional shape (perfect circular shape) of the fabrication material and the melting region are unlikely to favorably overlap each other.

It is preferable that the range of the inclination angle θ is

20°≤θ≤70°.

When the inclination angle θ is less than 20°, light reflected or diffused by the surface of the fabrication material layer returns to the light source via the irradiation unit to cause a fluctuation in light amount of the light source, which is a concern.

In addition, when the inclination angle θ is larger than 70 degrees, light specularly reflected by the irradiated surface is increased, and thus the immediately previous layer is likely to be insufficiently melted.

In the irradiation optical system described with reference to FIGS. 1A to 1C, in the irradiation unit 4, the direction of the optical axis 5 is the Z direction, two directions orthogonal to the optical axis 5 are the X direction and the Y direction, and a positive power in the X direction is set to be smaller than a positive power in the Y direction such that the condensing spot SP0 on the X-Y plane SB at a position where light from the light source unit 3 is condensed has an “elliptical shape having the X direction as the major axis”.

Such a power setting can be easily implemented when the irradiation unit includes “one or more anamorphic surfaces”.

The irradiation unit may be a mirror having the function of reflecting light. The mirror may be an axisymmetric mirror or may be a mirror having an anamorphic surface.

The irradiation unit may have a configuration where a plurality of lenses including anamorphic lenses in part is “arranged with a common optical axis”.

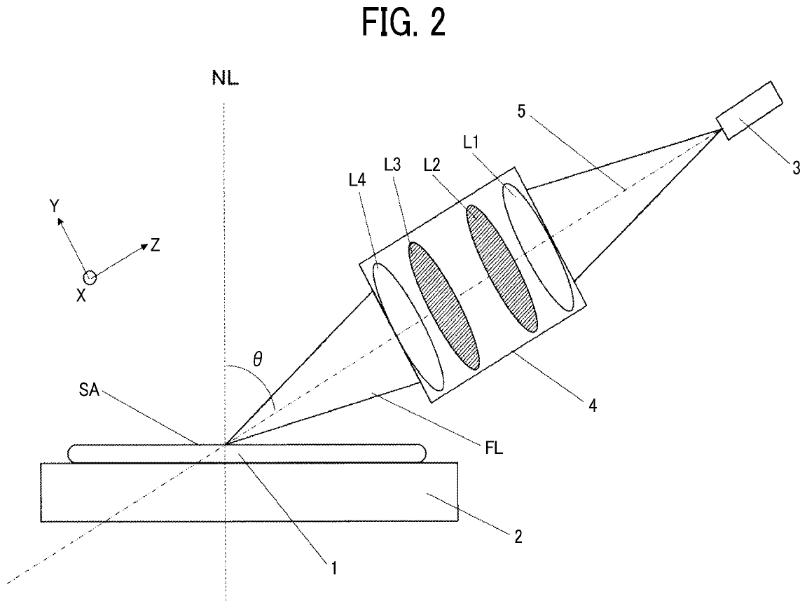

FIG. 2 illustrates an example where the irradiation unit 4 in the irradiation optical system described with reference to FIG. 1A includes four lenses L1, L2, L3, and L4.

The lenses L1 and L4 are “lenses rotationally symmetric with respect to the optical axis” and the lenses L2 and L3 are “anamorphic lenses”.

Hereinafter, four examples of the irradiation unit 4 illustrated in FIG. 2 will be provided.

As illustrated in FIG. 2, all of the irradiation units in the four examples include the four lenses L1 to L4. The lenses L1 and L4 are “first and second positive lenses” rotationally symmetric with respect to the optical axis, and the other two are cylinder lenses L2 and L3. The two cylinder lenses L2 and L3 are arranged to be interposed between the two positive lenses L1 and L4.

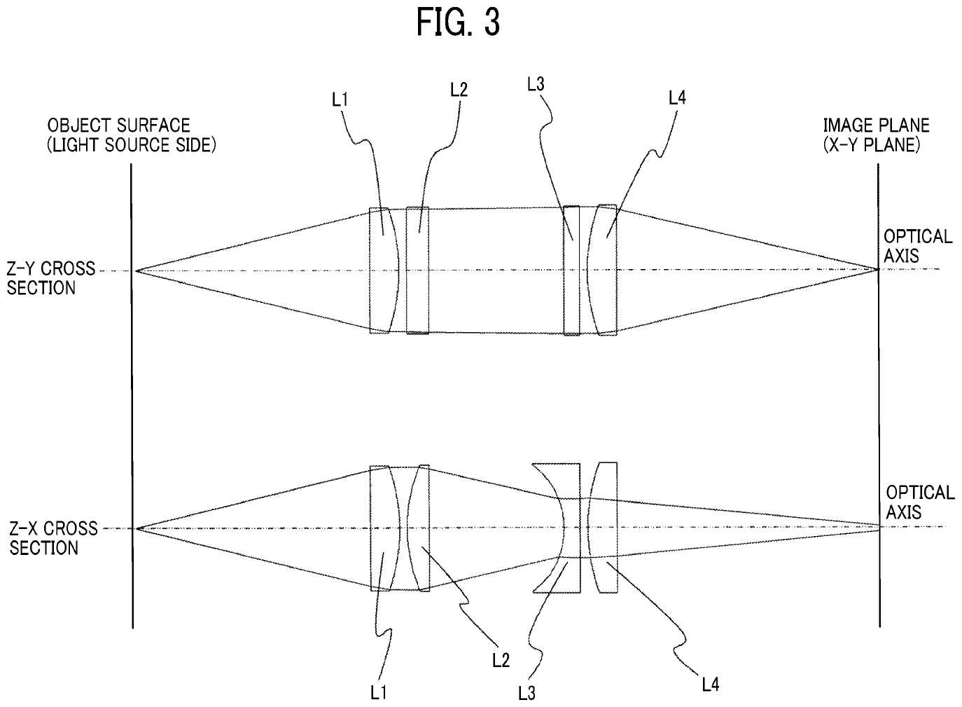

First to third examples are illustrated in FIGS. 3 to 5. In the first to third examples, among the lenses L 1 to L4 that are arranged from an object side to an image plane side, the lenses L1 and L4 are “positive lenses rotationally symmetric with respect to the optical axis”, the lens L2 is a “cylinder lens that has no power in the Y direction and has a positive power only in the X direction”, and the lens L3 is a “cylinder lens that has no power in the Y 3 5 direction and has a negative power only in the X direction”.

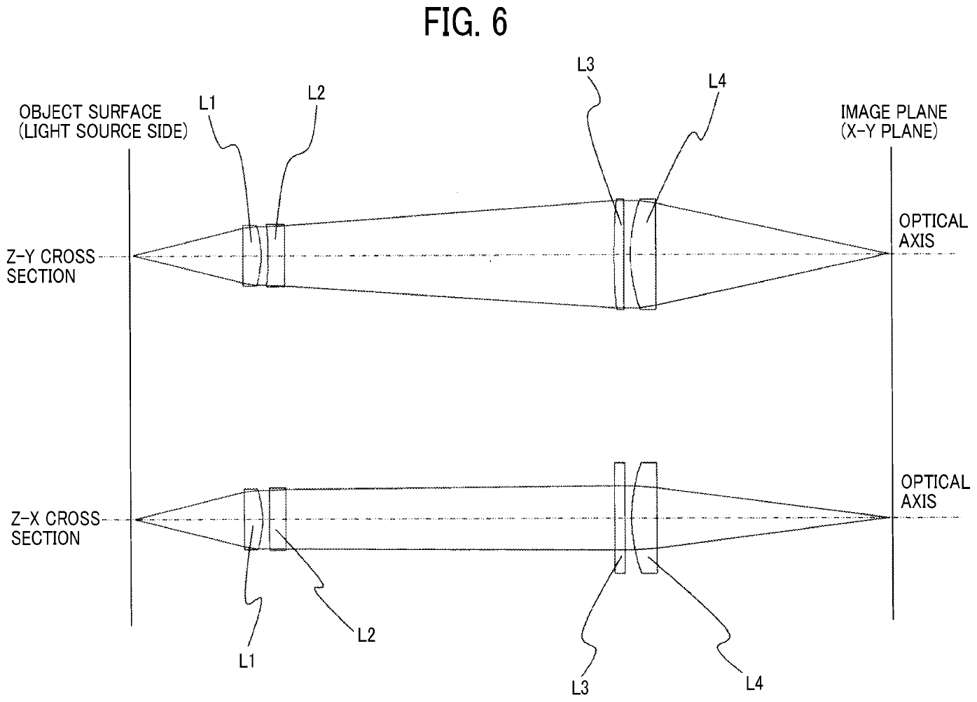

In a “fourth example” illustrated in FIG. 6, among the lenses L1 to L4 arranged from the object side to the image plane side, the lenses L1 and L4 are “positive lenses rotationally symmetric with respect to the optical axis”, the lens L2 is a “cylinder lens that has no power in the X direction and has a negative power only in the Y direction”, and the lens L3 is a “cylinder lens that has no power in the X direction and has a positive power only in the Y direction”.

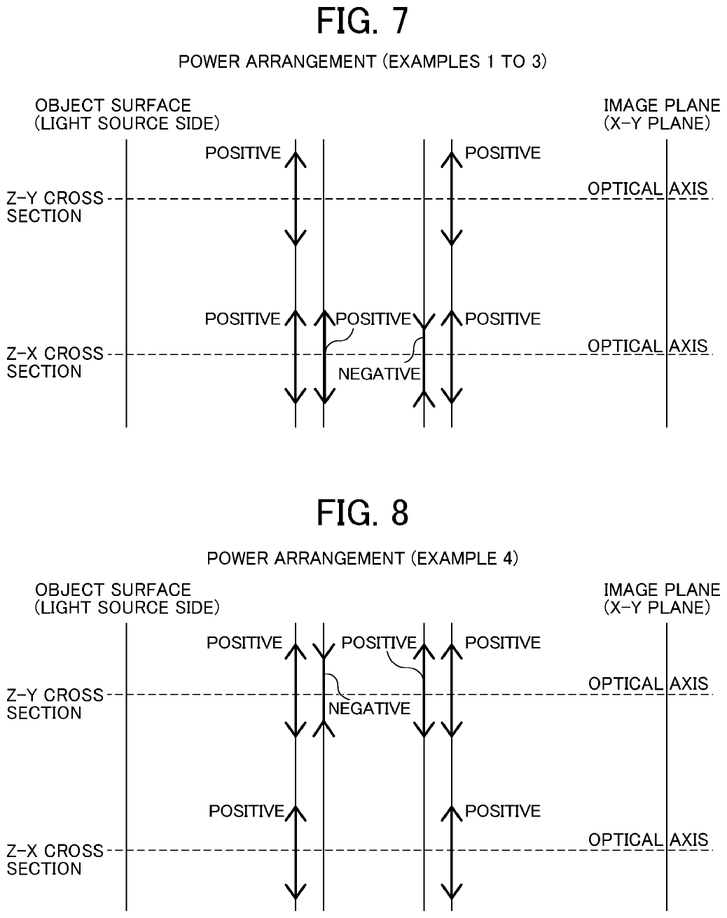

FIG. 7 is an illustration of a power arrangement in a Z-Y plane and a Z-X plane in the “first to third examples” illustrated in FIGS. 3 to 5. FIG. 8 is an illustration of a power arrangement in the Z-Y plane and the Z-X plane in the fourth example illustrated in FIG. 6. Hereinafter, specific examples of the first to third examples will be described as

Examples 1 to 3, and a specific example of the fourth example will be described as Example 4.

In Examples 1 to 4 provided hereinafter, the meaning of each symbol is as follows.

λ: dominant wavelength [nm]

Y: object height in the Y direction [mm]

X: object height in the X direction [mm]

NA: the number of openings on an object surface side (the number of openings in the X and Y directions: constant)

mY: magnification in the Y direction

mX: magnification in the X direction

ryi: radius of curvature of an i^{th} lens surface in the Y direction counting from an object surface [mm]

rxi: radius of curvature of an i^{th} lens surface in the X direction counting from the object surface [mm]

di: gap of an ^{th} surface counting from the object surface [mm]

nj: refractive index of the material of a j^{th} lens counting from the object side

vj: Abbe number of the material of the j^{th} lens counting from the object side

nd: refractive index of a d line

vd: Abbe number of the d line

In Example 1 to Example 3, aspherical surfaces are used in the lenses L1 and L4 rotationally symmetric with respect to the optical axis. In Example 4, an aspherical surface is used in the lens L4 rotationally symmetric with respect to the optical axis.

The aspherical surface is expressed by the following well-known equation using a distance D from “a tangent plane at an aspherical surface vertex” of the aspherical surface in a 3 5 height H from the optical axis, a paraxial radius of curvature R, a conic constant K, and aspherical surface coefficients A4, A6, A8, and A10.

D=(1/R)×H²/[1+√{1−(1+K)×(H/R)²}

+A4×H⁴+A6×H⁶+A10×H ¹⁰

### EXAMPLE 1

Example 1 is an example illustrated in FIG. 3.

λ=808 [nm], Y=0.15 [mm], X=0.15 [mm], NA=0.22, mY=1.1, and mX=2.9.

Data of Example 1 is illustrated in Table 1.

TABLE 1

| | Ry | Rx | d | nd | Nd | Remark |
|---|---|---|---|---|---|---|
| 1 | ∞ | ∞ | 44.5 | | | |
| 2 | ∞ | ∞ | 5.5 | 1.5891 | 61.2 | |
| 3 | −29.457 | −29.457 | 1.5 | | | Aspherical surface |
| 4 | ∞ | 25.84 | 4.65 | 1.5168 | 64.2 | Cylinder surface |
| 5 | ∞ | ∞ | 29.2 | | | |
| 6 | ∞ | −15.69 | 2.5 | 1.7847 | 25.7 | Cylinder surface |
| 7 | ∞ | ∞ | 1.5 | | | |
| 8 | 29.457 | 29.457 | 5.5 | 1.5891 | 61.2 | Aspherical surface |
| 9 | ∞ | ∞ | 50 | | | |

Aspherical surface data

Aspherical surface data is illustrated in Table 2.

TABLE 2

| Surface No. | K | A4 |
|---|---|---|
| 3 | −0.71 | −5.8398E−07 |
| 8 | −0.71 | 5.8398E−07 |

In the above notation, for example, “1.0101E-014” represents “1.0101×10⁻¹⁴”. The same applies below.

A light source takes laser light from a semiconductor laser, which emits laser light of 808 nm (near infrared light), into an optical fiber to emit the laser light from a light-emitting end of the optical fiber. An object surface 1 in Table 1 is a “circular light-emitting surface” of the optical fiber.

Since the object height Yin the Y direction is 0.15 mm and the object height X in the X direction is 0.15 mm, the above light-emitting surface has a circular shape with a “diameter of 0.3 mm”.

Regarding the image forming magnification of the irradiation unit by the lenses L1 to L4, mY in the Y direction is 1.1 and mX in the X direction is 2.9. Therefore, according to FIG. 1B, the diameter Dy of the condensing spot SPO on the X-Y plane SB is 0.3 mm ×1.1=0.33 mm, and the diameter Dx is 0.3 mm ×2.9=0.87 mm.

### EXAMPLE 2

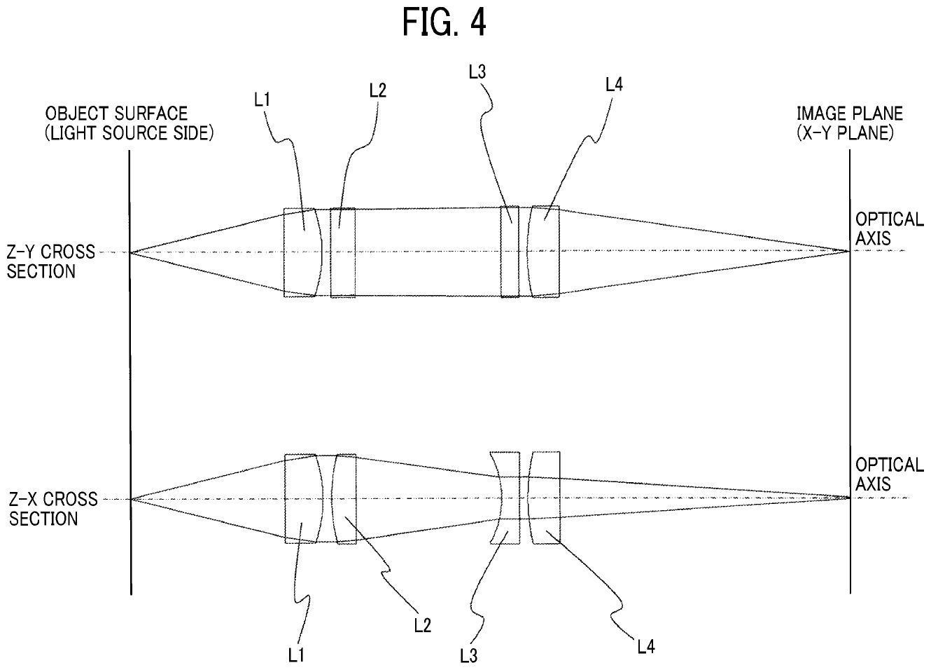

Example 2 is an example illustrated in FIG. 4.

λ=808 [nm], Y=0.15 [mm], X=0.15 [mm], NA=0.22, mY=1.7, and mX=4.4.

Data of Example 2 is illustrated in Table 3.

TABLE 3

| | Ry | Rx | d | nd | Nd | Remark |
|---|---|---|---|---|---|---|
| 1 | ∞ | ∞ | 26.5 | | | |
| 2 | ∞ | ∞ | 6.5 | 1.5891 | 61.2 | |
| 3 | −18.41 | −18.41 | 1.5 | | | Aspherical surface |
| 4 | ∞ | 25.84 | 4.65 | 1.5168 | 64.2 | Cylinder surface |
| 5 | ∞ | ∞ | 29.4 | | | |
| 6 | ∞ | −15.69 | 2.5 | 1.7847 | 25.7 | Cylinder surface |
| 7 | ∞ | ∞ | 1.5 | | | |
| 8 | 29.457 | 29.457 | 5.5 | 1.5891 | 61.2 | Aspherical surface |
| 9 | ∞ | ∞ | 50 | | | |

Aspherical surface data

Aspherical surface data is illustrated in Table 4.

TABLE 4

| Surface No. | K | A4 | A6 | A8 | A10 |
|---|---|---|---|---|---|
| 3 | −1.61 | −2.0635E−05 | 7.6490E−09 | −1.1176E−11 | 1.0101E−014 |
| 8 | −0.71 | 5.8398E−07 | | | |

A light source is the same as that in Example 1, and the object surface 1 has a circular shape with a “diameter of 0.3 mm”. Regarding the image forming magnification of the irradiation unit by the lenses L1 to L4, mY in the Y direction is 1.7 and mX in the X direction is 4.4. Therefore, the diameter Dy of the condensing spot SP0 formed on the X-Y plane SB is 0.3 mm ×1.7=0.51 mm, and the diameter Dx is 0.3 mm ×4.4=1.32 mm.

### EXAMPLE 3

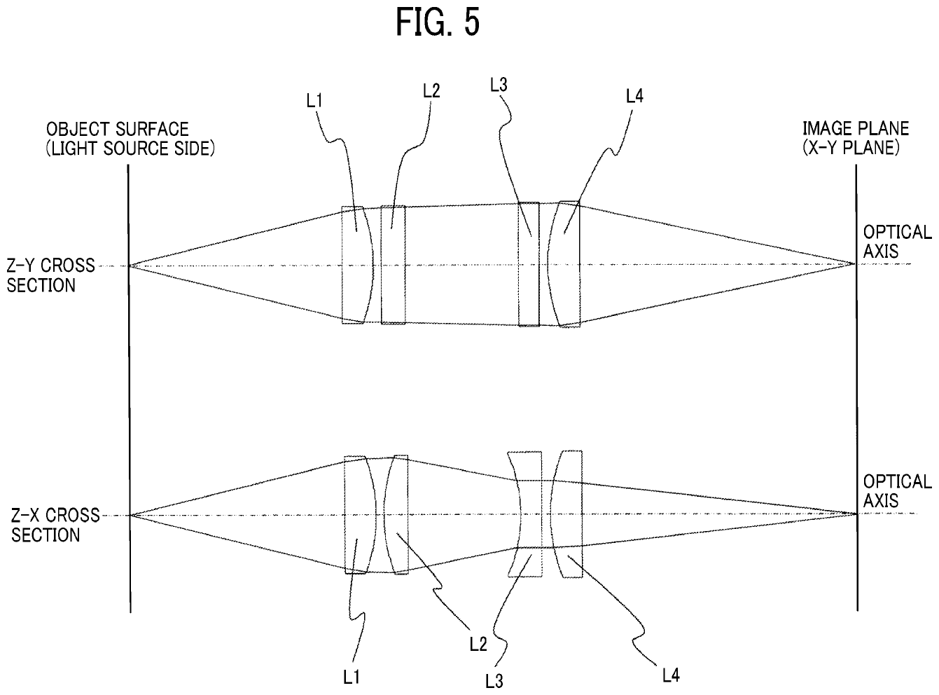

Example 3 is an example illustrated in FIG. 5.

λ=808 [nm], Y=0.1 [mm], X=0.1 [mm], NA=0.22, mY=1.2, and mX=2.2.

Data of Example 3 is illustrated in Table 5.

TABLE 5

| | Ry | Rx | d | nd | Nd | Remark |
|---|---|---|---|---|---|---|
| 1 | ∞ | ∞ | 40.6 | | | |
| 2 | ∞ | ∞ | 6 | 1.5168 | 64.2 | |
| 3 | −25.56 | −25.56 | 1.5 | | | Aspherical surface |
| 4 | ∞ | 25.84 | 4.65 | 1.5168 | 64.2 | Cylinder surface |
| 5 | ∞ | ∞ | 21.4 | | | |
| 6 | ∞ | −23.54 | 4 | 1.7847 | 25.7 | Cylinder surface |
| 7 | ∞ | ∞ | 1.6 | | | |
| 8 | 25.56 | 25.56 | 6 | 1.5168 | 64.2 | Aspherical surface |
| 9 | ∞ | ∞ | 52.3 | | | |

Aspherical data

Aspherical surface data is illustrated in Table 6.

TABLE 6

| Surface No. | K | A4 | A6 | A8 |
|---|---|---|---|---|
| 3 | −1.01 | −3.2704E−06 | −7.7205E−10 | −1.6305E−13 |
| 8 | −1.01 | 3.2704E−06 | −7.7205E−10 | −1.6305E−13 |

A light source takes laser light from a semiconductor laser, which emits laser light of 808 nm (near infrared light), into an optical fiber to emit the laser light from a light-emitting end of the optical fiber. The object surface 1 is a “circular light-emitting surface” of the optical fiber, and the above light-emitting surface has a circular shape with a “diameter of 0.2 mm”.

Regarding the image forming magnification of the irradiation unit by the lenses L1 to L4, mY in the Y direction is 1.2 and mX in the X direction is 2.2. Therefore, the diameter

Dy of the condensing spot SPO formed on the X-Y plane SB is 0.2 mm×1.2=0.24 mm, and the diameter Dx is 0.2 mm×2.2=0.44 mm.

### EXAMPLE 4

Example 4 is an example illustrated in FIG. 6.

λ=808 [nm],Y=0.1 [mm], X=0.1 [mm], NA=0.22, mY=1.1, and mX=1.8.

Data of Example 4 is illustrated in Table 7.

TABLE 7

| | Ry | Rx | d | nd | Nd | Remark |
|---|---|---|---|---|---|---|
| 1 | ∞ | ∞ | 23.6 | | | |
| 2 | ∞ | ∞ | 3.8 | 1.6727 | 32.2 | |
| 3 | −18.16 | −18.16 | 1.5 | | | |
| 4 | −51.68 | ∞ | 3.5 | 1.5168 | 64.2 | Cylinder surface |
| 5 | ∞ | ∞ | 71 | | | |
| 6 | 103.36 | ∞ | 2.1 | 1.5168 | 64.2 | Cylinder surface |
| 7 | ∞ | ∞ | 1.5 | | | |
| 8 | 29.457 | 29.457 | 5.5 | 1.5891 | 61.2 | Aspherical surface |
| 9 | ∞ | ∞ | 50 | | | |

Aspherical surface data

Aspherical surface data is illustrated in Table 8.

TABLE 8

| Surface No. | K | A4 |
|---|---|---|
| 8 | −0.71 | 5.8398E−07 |

A light source is the same as that in Example 3, and the light-emitting surface has a circular shape with a “diameter of 0.2 mm”.

Regarding the image forming magnification of the irradiation unit by the lenses L1 to L4, mY in the Y direction is 1.1 and mX in the X direction is 1.8. Therefore, the diameter Dy of the condensing spot SP0 on the X-Y plane SB is 0.2 mm×1.1=0.22 mm, and the diameterDx is 0.2 mm×1.8=0.36 mm.

Examples 1 to 3 adopt a configuration where the aspherical surface lenses L1 and L4 reduces the width of irradiation light in the Y direction and the anamorphic lenses L2 and L3 weaken (blur) reducing the width of the irradiation light in the X direction.

Example 4 adopts a “configuration where the anamorphic lens L3 reduces the width of irradiation light in the Y direction”. The aspherical surface lenses L1 and L4 condense light in the X direction.

In Examples 1 to 3, the total lens length (distance from a light incident surface of the lens L1 to a light-emitting surface of the lens L4 in the direction of the optical axis) can be shortened.

The reason is that the aspherical surface lenses L1 and L4 reduce the width of irradiation light and thus the size of the lens can be reduced.

In Example 4, the aberration is generated by the number of surfaces of the anamorphic lenses L2 and L3 and thus the negative power of the anamorphic lens L2 is reduced. In this case, unless the gap between the anamorphic lenses L2 and L3 is increased, the width of the irradiation light in the Y direction cannot be reduced, and thus the total lens length becomes long.

Namely, as illustrated in FIG. 6, the refractive action of the lenses L2 and L3 having anamorphic surfaces makes a difference in condensing angle between the two directions (the

X direction and the Y direction) orthogonal to each other.

In a Z-Y cross section, a beam bundle permeating the optical system becomes thick due to the refractive action, and thus the condensing angle becomes wide. Meanwhile, in a Z-X cross section, the beam bundle permeating the optical system becomes thin due to the refractive action, and thus the condensing angle becomes narrow. In this case, when light is vertically incident (inclination angle:)0°, the irradiation diameter is flat.

In Example 4, one optical element having an aspherical surface (lens L4) is used, and thus the spherical aberration is corrected; and thereby, the diameter of light to be emitted can be reduced.

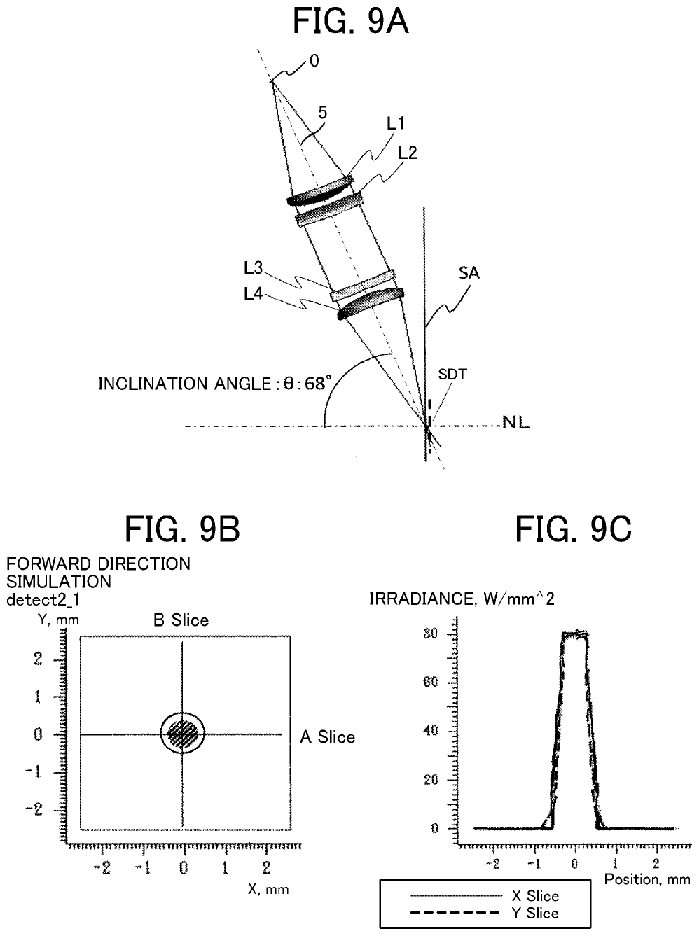

In the irradiation optical system of Examples 1 to 4 described above, examples where when the inclination angle θ of the optical axis is set to a specific value, the state of the irradiation spot is obtained by simulation are illustrated in FIGS. 9 to 12.

In the drawings, a light source 0 (light-emitting surface in the above description) used in the simulation is as follows.

Surface light source: circular shape with a radius Y [mm] (numerical value of Y described in Tables 1, 3, 5, and 7)

Wavelength: 808 [nm]

Light-emitting angle: 12. 7 degrees (NA: 0.22)

Light output: 45 [W]

Spatial distribution: uniform

Angular distribution: uniform

Number of beams: 50 million

Light from the light source O is incident into the irradiation unit, a “light receiver” is arranged as follows on a surface (corresponding to the irradiated surface) inclined at a predetermined angle with respect to a light condensing surface, and the state of the irradiation spot of an imaging forming light bundle is obtained by a “beam tracing simulation”.

Standard of light receiver

Light-receiving region: 5 [mm]×5 [mm]

Number of divisions of light receiver: 500 [cell]×500 [cell]

In the simulation, the diameter of the light intensity distribution, at which the intensity has a peak value (1/e²) in the light intensity distribution of the irradiation spot on the light-receiving region, is defined as the “diameter of the irradiation spot”.

FIG. 9A illustrates an optical arrangement when the irradiation unit described in Example 1 is used. A surface denoted by reference sign SA corresponds to the irradiated surface illustrated in FIGS. 1A to 1C, and the position of a light-receiving surface SDT of the light receiver is set to an irradiation position on the surface SA. The inclination angle θ that is formed by the normal line NL of the surface SA and the optical axis 5 of the irradiation unit is set to “68°”.

FIG. 9A illustrates a state in the Y-Z plane similarly as in FIG. 1A. FIG. 9B illustrates an irradiation distribution, namely, the state of the “irradiation spot” in the light-receiving surface SDT of the light receiver. FIG. 9C illustrates irradiance (W/mm²) at A Slice (X-Z cross section including the optical axis) and B Slice (η-Z cross section including the optical axis) in FIG. 9B. The longitudinal direction (denoted by Y) in FIG. 9B is the η direction in FIG. 1C. 3 0 As illustrated in FIG. 9B, the diameter of the irradiation spot in the longitudinal direction is 1.1 mm, the diameter in the lateral direction is 1.1 mm, and the aspect ratio is 1. Namely, the irradiation spot has a perfect circular shape.

Regarding Example 1 above, the diameters Dy and Dx of the condensing spot SP0 on the X-Y plane SB are geometrically and optically calculated to obtain Dy=0.33 mm and Dx=0.87 mm.

Due to (1/cos 68°)≈2.67, the diameter Dη of the irradiation spot in geometrical optics is Dy×2.67=0.33×2.67=0.8811 which is approximately the same as Dx (=0.87), and thus Dη/Dx=1.01. The result corresponds well to a result of the above simulation.

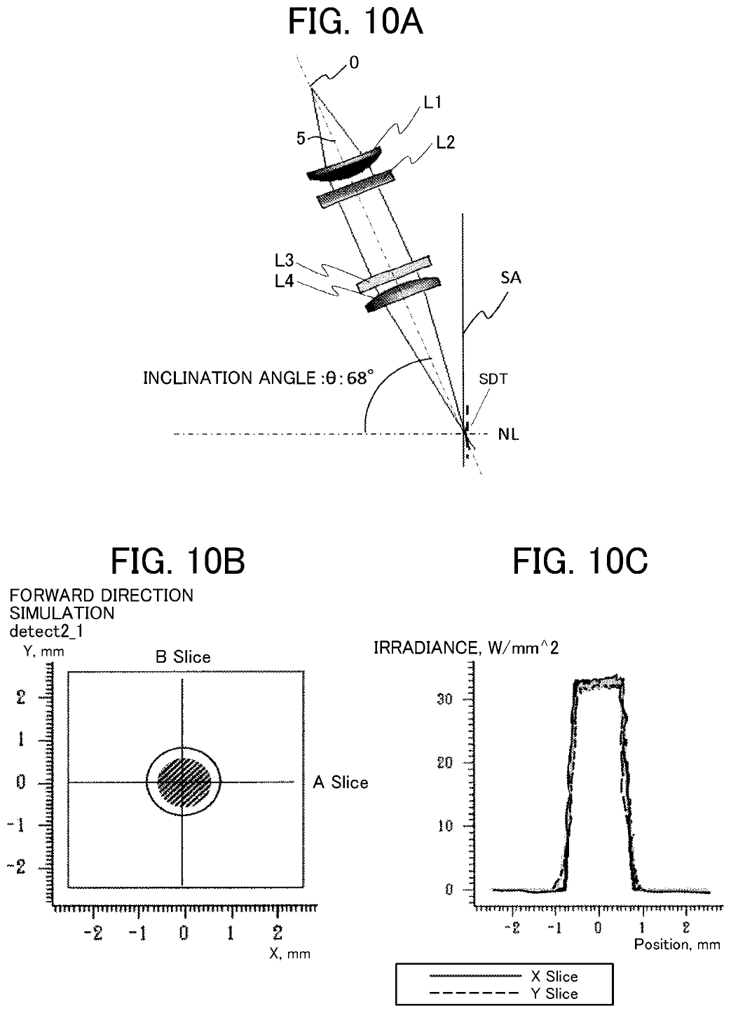

FIGS. 10A to 10C illustrate a result of the simulation when the irradiation unit illustrated in Example 2 is used at an inclination angle θ of 68°, as in FIGS. 9A to 9C.

As illustrated in FIG. 10B, the diameter of the irradiation spot in the longitudinal direction is 1.5 mm, the diameter in the lateral direction is 1.6 mm, the aspect ratio is 1.1, and the irradiation spot has a substantially perfect circular shape.

In Example 2, the spot diameters Dy and Dx which are geometrically and optically calculated are 0.51 mm and 1.32 mm, respectively, the diameter Dη of the irradiation spot for an inclination angle θ of 68° is 0.51×2.67=1.36, and Dη/Dx=1.36/1.32=1.03, and thus the result corresponds well to the result of the simulation.

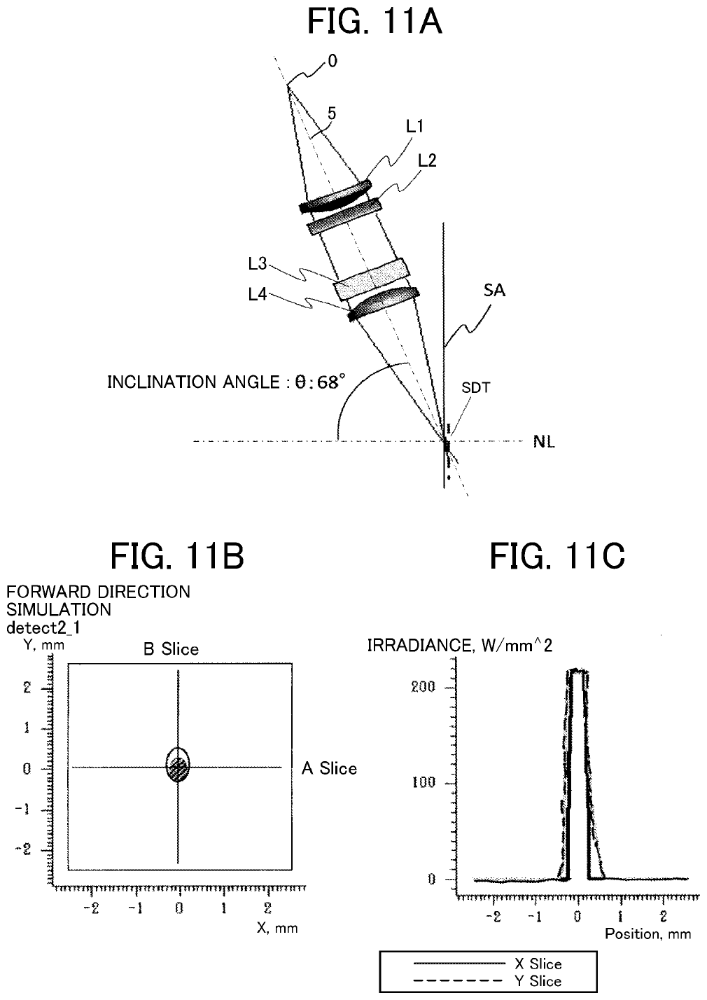

FIGS. 11A to 11C illustrate a result of the simulation when the irradiation unit illustrated in Example 3 is used at an inclination angle θ of 68°, as in FIGS. 9A to 9C.

As illustrated in FIG. 11B, the diameter of the irradiation spot in the longitudinal direction is 0.5 mm, the diameter in the lateral direction is 0.8 mm, the aspect ratio is 1.6, and the irradiation spot has an elliptical shape.

In Example 3, the spot diameters Dy and Dx which are geometrically and optically calculated are 0.24 mm and 0.44 mm, respectively, the diameter Dη of the irradiation spot for an inclination angle θ of 68° is 0.24×2.67=0.64, and Dη/Dx=0.64/0.44=1.46, and thus the results corresponds well to the result of the simulation.

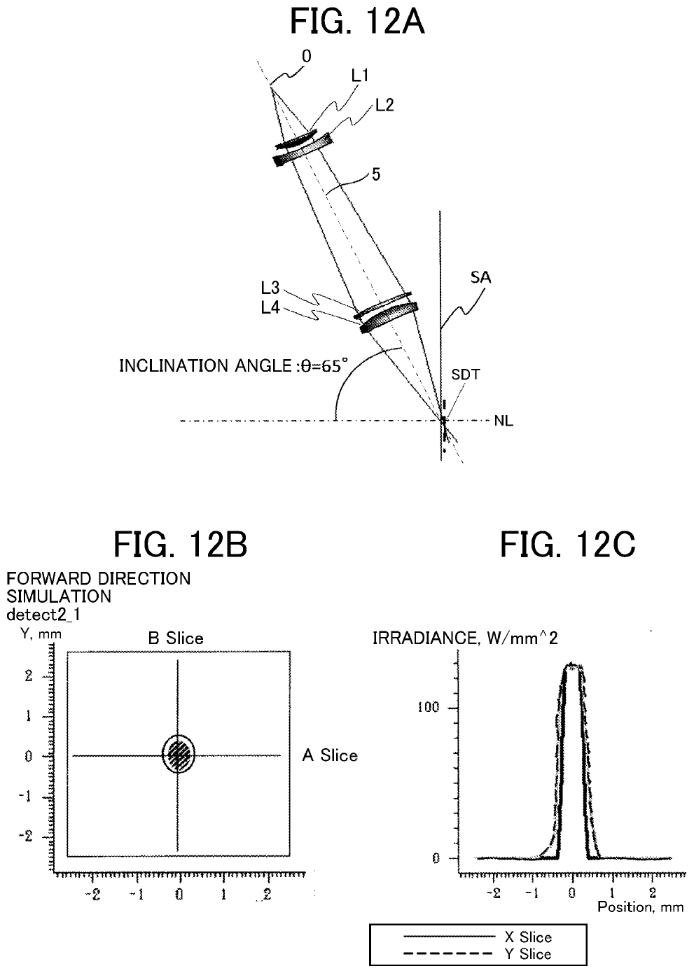

FIGS. 12A to 12C illustrate a result of the simulation when the irradiation unit illustrated in Example 4 is used at an inclination angle θ of 65°, as in FIGS. 9A to 9C.

As illustrated in FIG. 12B, the diameter of the irradiation spot in the longitudinal direction is 0.7 mm, the diameter in the lateral direction is 1.0 mm, the aspect ratio is 1.4, and the irradiation spot has an elliptical shape.

In Example 4, the spot diameters Dy and Dx which are geometrically and optically calculated are 0.22 mm and 0.36 mm, respectively, the diameter Dη of the irradiation spot for an inclination angle θ of 65° is 0.22×2.36=0.53, and Dη/Dx=0.53/0.36=1.47, and thus the result corresponds well to the result of the simulation.

In Examples 3 and 4, “the irradiation spot has an elliptical shape” and according to the results of the simulation, the aspect ratios (Dη/Dx) are 1.6 and 1.4, respectively.

The values are within a range of the above-described condition for Dη/Dx, namely, 1.8≥Dη/Dx≥0.8.

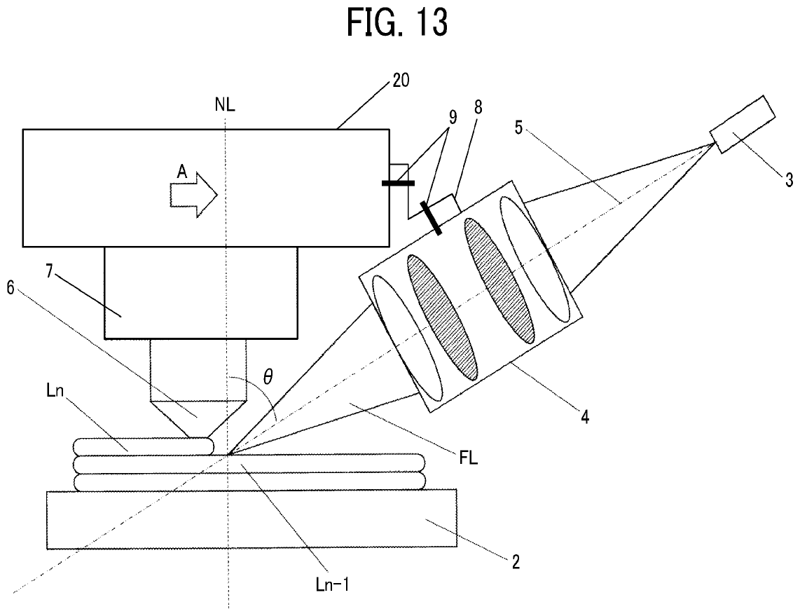

FIG. 13 is a descriptive view illustrating the three-dimensional fabricating apparatus according to an embodiment of the present disclosure.

In order to avoid complication, parts that are less likely to cause confusion are given the same reference signs as those in FIGS. 1A to 1C.

The three-dimensional fabricating apparatus is “a three-dimensional fabricating apparatus that stacks layers of the fabrication material forming a three-dimensional shape on the placement surface while displacing the placement surface of the placement table 2 in a stepwise manner in the direction of the normal line NL, to form the three-dimensional shape”.

In FIG. 13, reference sign 6 denotes a “nozzle” and reference sign 7 denotes a “heating block”. A nozzle 6 and a heating block 7 form a “material supplier”. A carriage 20 as a mover holds the material supplier and two-dimensionally moves the nozzle 6 and the heating block 7 as an integrated unit in a direction parallel to the placement surface of the placement table 2. The two-dimensional movement direction is indicated by arrow A. The irradiation unit 4 is secured to the carriage 20 with screws 9 via a connecting member 8 of, e.g., an L-shape. The carriage 20, the connecting member 8, and the screws 9 serve as a holder to hold the irradiation unit 4.

The placement table 2 is displaced “downward in a stepwise manner” in the direction of the normal line NL of the placement surface.

The fabrication material such as resin is melted in the heating block 7 to be pushed out and discharged in a molten state from the nozzle 6 onto the placement surface. While discharging the fabrication material, the material supplier is two-dimensionally displaced in a direction A parallel to the placement surface to sequentially stack a large number of layers, into which a three-dimensional shape to be fabricated is cut, from a first layer. Whenever one layer is formed, the placement table 2 moves by the “thickness of one layer” in the direction of the normal line NL (downward in FIG. 13).

In FIG. 13, reference sign Ln−1 denotes an n−1 ^{th} layer (hereinafter, referred to as an “immediately previous layer Ln−1”) that is stacked. Reference sign Ln denotes an n^{th} layer that is actually being stacked on the “immediately previous layer Ln−1”.

In the irradiation optical system including the light source unit 3 and the irradiation unit 4, the direction of the optical axis is inclined by the angle θ with respect to the direction of the normal line NL, light emitted from the light source unit 3 forms an “irradiation spot” on the immediately previous layer Ln−1, and an irradiation region of the immediately previous layer Ln−1 which is irradiated with the irradiation spot is melted.

A portion irradiated with the irradiation spot is at a position immediately ahead of where the nozzle 6 discharges the fabrication material. The nozzle 6 discharges the fabrication material to a “region that is irradiated with the irradiation spot to enter a molten state” of the immediately previous layer Ln−1.

Namely, the irradiation spot irradiates the position immediately ahead of where the nozzle 6 discharges the fabrication material.

The discharge supply of the fabrication material by the nozzle 6 is performed depending on the “shape of the n^{th} layer to be fabricated”. The discharge position is two-dimensionally displaced in the direction parallel to the placement surface according to data corresponding to the shape.

Therefore, the irradiation position of the irradiation spot has to also be two-dimensionally displaced in advance of the discharge position.

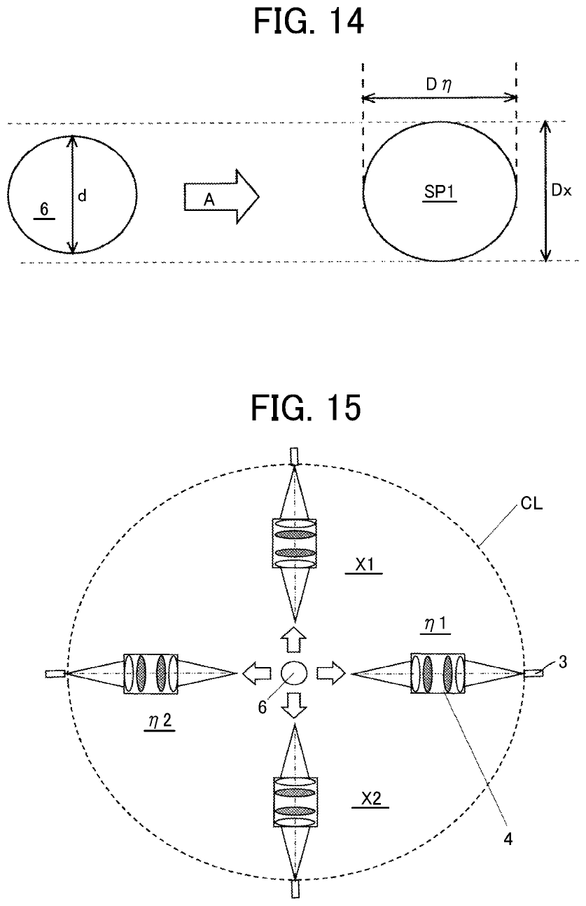

FIG. 14 is a descriptive view illustrating a positional relationship between the nozzle 6 (opening shape of a portion discharging the fabrication material) and the irradiation spot SP 1.

The irradiation spot SP1 has the spot diameter Dx in the X direction and the spot diameter Dη in the η direction; however, this example illustrates the case of a perfect circular shape (Dx=Dη).

An opening of the nozzle 6 has a circular shape, and a diameter (opening diameter) d of the opening is slightly smaller than the diameter Dx of the irradiation spot SP1 in the X direction.

When viewed from the irradiation spot SP1 side, it is appropriate that the diameters Dx and Dη of the irradiation spot are approximately the same as the opening diameter d or approximately 2 times the opening diameter.

As illustrated in FIG. 14, when the opening of the nozzle 6 moves in the direction A toward the position irradiated with the irradiation spot SP1, to reach (overlap) the irradiation position, the fabrication material is discharged to the position.

FIG. 15 is an illustration of one example of movement of the irradiation optical system (the light source unit 3 and the irradiation unit 4).

Namely, when the nozzle 6 moves rightward (leftward) in the drawing, the irradiation optical system takes postures denoted by reference signs η1 (η2) in advance of the movement, and when the nozzle moves upward (downward) in the drawing, the posture of the irradiation 3 0 optical system is switched to postures denoted by reference signs X1 (X2) in advance of the movement.

The irradiation optical system is provided integrally with the material supplier to make a “precessional motion” along a circle CL in a state where an axis parallel to the normal line NL through the center of the nozzle 6 is used as a rotation axis and the inclination angle θ is maintained constant, and the irradiation optical system switches between the postures X1

X2, η1, and η2 in advance of the movement of the nozzle 6 according to fabrication data.

In this case, as illustrated in FIG. 14, in the irradiation spot SP1, the movement direction of the nozzle 6 coincides with the η direction at all times.

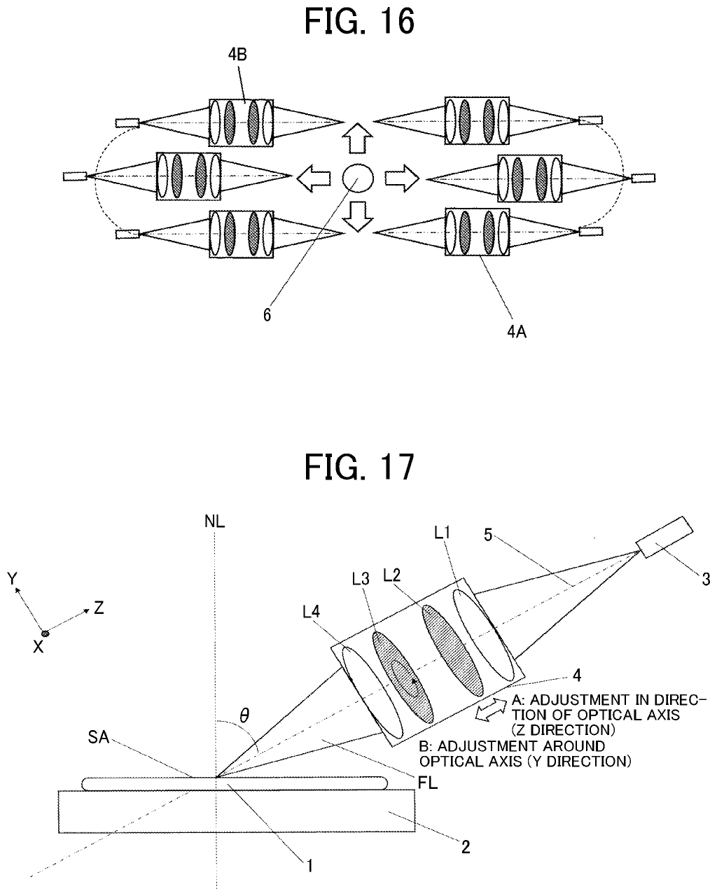

FIG. 16 is an illustration of another example of switching the position of the irradiation optical system.

In this example, two sets of irradiation optical systems 4A and 4B are provided symmetrically with respect to the position of the nozzle 6 in a rightward and leftward direction.

The two sets of irradiation optical systems use a position, which is different from the position of the nozzle 6, as a rotation axis, and “move translationally with the inclination angle θ maintained” while drawing a circular trajectory according to the movement direction of the nozzle 6.

In this case, regardless of the movement of the irradiation optical system, the irradiation spot maintains the same posture (direction) at all times. The irradiation unit 4 described above includes four lenses, two of the lenses are lenses rotationally symmetric with respect to the optical axis, and the other two are anamorphic lenses.

In order for the irradiation optical system to form a “proper shape of an irradiation spot” on the irradiated surface, the mutual positional relationship between the four lenses has to be accurately determined.

When assembly is performed such that the positional relationship is accurate, the assembly work requires precision and the manufacturing cost of the irradiation unit is likely to increase.

As illustrated in FIG. 17, for example, in a case when the anamorphic lens L2 can be adjusted to move in the direction of the optical axis and the anamorphic lens L3 can be adjusted to rotate around the optical axis, the assembly work becomes simplified. Therefore, when the irradiation optical system is assembled to the three-dimensional fabricating apparatus, adjustment is performed to be able to form a proper irradiation spot.

The “focus adjustment” can be performed by adjusting the movement of the lens L2 3 0 in the direction of the optical axis, and the disturbance of a wave front is adjusted by adjusting the rotation of the lens L3 around the optical axis, and thus the shape of the irradiation spot can be properly adjusted.

Although the desirable embodiments and examples of the disclosure have been described above, the disclosure is not particularly limited to such specific embodiments and examples unless otherwise particularly limited in the above description, and various modifications and changes can be made without departing from the spirit and scope of the disclosure as set forth in the appended claims.

For example, the irradiation unit may include two, three, or five or more lenses, and one or more of the lenses may be anamorphic lenses.

The light source unit is a “laser light source that emits isotropic divergent light”; however, the light source unit is not limited to the laser light source and may be a light source other than a laser.

In the above, light irradiation is performed by the irradiation optical system to “melt the immediately previous layer”; however, the light irradiation by the irradiation optical system can be used to sinter or process a material.

The advantageous effects described in the embodiments and examples of the disclosure are merely desirable advantageous effects generated based on the disclosure. The advantageous effects according to the disclosure is not limited to “those described in the embodiments and examples”.

Numerous additional modifications and variations are possible in light of the above teachings. It i s therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

1. An irradiation optical system comprising:
a light source unit; and
an irradiation unit configured to condense light from the light source unit onto an irradiated surface to irradiate the irradiated surface with the light,
wherein in the irradiation unit, a direction of an optical axis is a Z direction, two directions orthogonal to the optical axis and orthogonal to each other are an X direction and a Y direction, and a positive power in the X direction is set to be smaller than a positive power in the Y direction such that a condensing spot on an X-Y plane at a position where the light from the light source unit is condensed has an elliptical shape having the X direction as a major axis.

2. The irradiation optical system according to claim 1,
wherein the irradiation unit includes one or more anamorphic surfaces.

3. The irradiation optical system according to claim 2,
wherein the irradiation unit includes a plurality of lenses to which the optical axis is common, and at least one of the plurality of lenses is an anamorphic lens.

4. The irradiation optical system according to claim 3,
wherein among the plurality of lenses, non-anamorphic lenses that are not the anamorphic lens are rotationally symmetric with respect to the optical axis, and one or more of the non-anamorphic lenses rotationally symmetric with respect to the optical axis are aspherical surface lenses.

5. The irradiation optical system according to claim 4,
wherein the irradiation unit includes four lenses, two of the four lenses are a first positive lens and a second positive lens rotationally symmetric with respect to the optical axis, and the other two of the four lenses are a first cylinder lens having a positive power in the X direction and a second cylinder lens having a negative power in the X direction.

6. The irradiation optical system according to claim 5,
wherein the first cylinder lens and the second cylinder lens are interposed between the first positive lens and the second positive lens, and at least one of the first positive lens and the second positive lens is an aspherical surface lens.

7. The irradiation optical system according to claim 6,
wherein the four lenses are arranged from a light source unit side toward an irradiated surface side in an order of the first positive lens, the first cylinder lens, the second cylinder lens, and the second positive lens, and both of the first positive lens and the second positive lens are aspherical surface lenses.

8. The irradiation optical system according to claim 6,
wherein the four lenses are arranged from a light source unit side toward an irradiated surface side in an order of the first positive lens, the second cylinder lens, the first cylinder lens, and the second positive lens, and the second positive lens is an aspherical surface lens.

9. The irradiation optical system according to claim 3,
wherein some of the plurality of lenses are anamorphic lenses, and
one or more of the anamorphic lenses are adjustable to move in the direction of the optical axis.

10. The irradiation optical system according to claim 3,
wherein some of the plurality of lenses are anamorphic lenses, and one or more of the anamorphic lenses are adjustable to rotate around the direction of the optical axis.

11. The irradiation optical system according to claim 1,
wherein the light source unit is a laser light source configured to emit isotropic divergent light.

12. A light irradiation device comprising:
the irradiation optical system according to claim 1 configured to irradiate the irradiated surface with light; and
a holder configured to hold the irradiation unit in the irradiation optical system such that the Z direction is inclined to the Y direction by an inclination angle θ with respect to a direction of a normal line of the irradiated surface and an irradiation spot in which a diameter of the condensing spot in the Y direction is 1/cos θ times a diameter of the condensing spot in he X direction is formed on the irradiated surface.

13. The light irradiation device according to claim 12,
wherein on the irradiated surface, when a direction corresponding to the Y direction is defined as an η direction, a ratio Dη/Dx between a diameter Dη of the irradiation spot in the η direction and a diameter Dx in the X direction is set within a range of 1.8≥Dη/Dx≥0.8.

14. The light irradiation device according to claim 12,
wherein the inclination angle θ of the irradiation unit is set within a range of 20°≤θ≤70°.

15. The light irradiation device according to claim 12,
wherein the irradiation unit is two-dimensionally displaceable in a direction parallel to the irradiated surface while maintaining the inclination angle θ.

16. The light irradiation device according to claim 15,
wherein the irradiation unit is rotatable around a rotation axis parallel to the normal line of the irradiated surface.

17. The light irradiation device according to claim 15,
wherein the irradiation unit is movable two-dimensionally and translationally in the direction parallel to the irradiated surface.

18. A three-dimensional fabricating apparatus configured to stack layers of a fabrication material forming a three-dimensional shape on a placement surface while 2 5 displacing the placement surface of a placement table in a stepwise manner in a direction of a normal line of the placement surface, to form the three-dimensional shape, the apparatus comprising:
a material supplier configured to supply the fabrication material onto the placement surface from the direction of the normal line; and
the light irradiation device according to claim 12 configured to irradiate a vicinity of a supply portion, to which the material supplier supplies the fabrication material, with light while supplying the fabrication material from the material supplier onto an immediately previous layer formed of the fabrication material supplied from the material supplier, to melt the immediately previous layer in the vicinity.

19. The three-dimensional fabricating apparatus according to claim 18,
wherein the irradiation unit of the light irradiation device is two-dimensionally displaceable in a direction parallel to the irradiated surface while maintaining the inclination angle θ, and
wherein the light irradiation device is coupled to the material supplier.

20. The three-dimensional fabricating apparatus according to claim 18, further comprising two irradiation units, including the irradiation unit, configured to move rotationally around two rotation axes separate from an axis of the material supplier while maintaining directions of optical axes of the two irradiation units,
wherein each of the two irradiation units is two-dimensionally displaceable in a direction parallel to the irradiated surface while maintaining the inclination angle θ, and
wherein each of the two irradiation units is movable two-dimensionally and translationally in the direction parallel to the irradiated surface.
